(19) United States
(12) Patent Application Publication
(10) Pub. No.: US 2015/0053103 A1
(43) Pub. Date: Feb. 26, 2015

(54) Method of Developing a Lithographic Printing Plate Including Post Treatment

(71) Applicant: Anocoil Corporation, Rockville, CT (US)

(72) Inventors: Howard A. Fromson, Stonington, CT (US); William J. Ryan, North Granby, CT (US); Anthony Paul Kitson, Suffield, CT (US); Brian L. Anderson, Westfield, MA (US)

(21) Appl. No.: 14/478,312

(22) Filed: Sep. 5, 2014

Related U.S. Application Data
(63) Continuation-in-part of application No. PCT/US2013/029378, filed on Mar. 6, 2013.

(51) Int. Cl. B41C 1/10

(52) U.S. Cl. CPC B41C 1/1008
USPC 101/467

(57) ABSTRACT

A method for producing a lithographic plate from a negative working, radiation imageable plate having an oleophilic resin coating that reacts to radiation by cross linking and is non-ionically adhered to a hydrophilic substrate. The steps include imagewise radiation exposing the coating to produce an imaged plate having partially reacted image areas at an initial double bond conversion rate including unreacted coating material, and completely unreacted nonimage areas; developing the plate by removing only the unreacted, nonimage areas from the substrate while retaining unreacted material in the image areas; and subjecting the upper surface of the plate to blanket post treatment energy, which further reacts the retained unreacted material in the image areas to increase the initial double bond conversion rate, producing a lithographic printing plate with enhanced durability.

### BACKGROUND

The present invention relates to lithographic printing plates.

Plates of interest have a solvent-soluble, radiation-polymerizable, oleophilic resin coating on a hydrophilic substrate. In conventional practice, after image-wise exposure at ultraviolet (UV), visible (violet), or infrared (IR) wavelengths, the plates are developed with solvent to remove the unexposed areas of the coating by dissolution, thereby producing a substantially planographic pattern of oleophilic and hydrophilic areas. The developed plates are then ready for mounting on a cylinder of a printing press, where the plates are subjected to fountain fluid and ink for transfer of ink to a target surface according to the pattern of oleophilic and hydrophilic areas on the plate.

The imaging radiation produces a cross-linking reaction in the imaged areas, which increases the mechanical adhesion of the image areas to the grained surface of the substrate, and also increases the cohesion (hardening) of the image area so that it can withstand the abrasive effect of receiving and transferring ink during the production run on-press.

Thermally imageable plates are commercially available, which require no pre-heat step prior to development. These plates usually have relatively low resolution and short press lives. The main reason for this is that they need more imaging exposure energy in order to gain integrity for the image. When an image is created in this manner it causes the “dots” or pixels that form the image to gain surface area. This phenomenon is called “dot gain” and causes degradation in the resolution of the plate.

As an alternative, the plate can be exposed at lower imaging energy and then pre-heated before development, but “dot gain” still occurs. However, in this case it is the excess energy of the heater that causes the “dot gain”. This energy (in the form of heat) forces the polymerization to continue not only in the center of the dots (which is needed for longer press life) but it also causes the dots to grow out from the edges.

There are known advantages to imaging coatings sensitive to violet and ultra-violet (UV) energy. However, a major disadvantage of violet sensitive coatings is the very high sensitivity to low levels of ambient light, thus requiring more complex imaging and processing systems. Also, typical imaging equipment cannot generate high intensity beams, so preheating after imaging is necessary.

Regardless of how plate manufacturers and end users make this tradeoff, in conventional solvent based development of negative, actinically imageable lithographic plates, no substantial further cross-linking can be achieved in the image areas after development of the plate in the solvent. Any coating material in the image areas that did not react with the radiation, is dissolved and therefore removed from the image areas during the development step.

### SUMMARY

The present invention addresses and minimizes the necessity of such tradeoff. The disclosed method achieves the remarkable combination of significantly reducing the imaging time, increasing the resolution, and increasing the hardness and thus on-press life of the printable plate. The method produces a plate with high resolution, long press life, using low power imaging, and low energy post treatment.

This method is based on the combination of (i) a coating formulation that yields an image of high resolution when image-wise exposed to a source of radiation; (ii) a coating formulation that when exposed to such imaging has sufficient image integrity to survive the development step with negligible loss of the active ingredients; (iii) a developer that does not leach out or destroy the active ingredients of the image areas; and (iv) a low power post energy treatment.

In one aspect, the disclosure is directed to a method for producing a lithographic printing plate from a negative working, radiation imageable plate having an oleophilic resin coating material that reacts to radiation by cross linking and is non-ionically adhered to a hydrophilic substrate, comprising: imagewise radiation exposing the coating to produce an imaged plate having partially reacted image areas at an initial double bond conversion percent, including unreacted coating material, and completely unreacted nonimage areas; without preheating the plate, developing the plate to remove only the unreacted, nonimage areas from the substrate while retaining unreacted material in the image areas; and blanket exposing the developed plate to an external source of energy, thereby increasing the initial double bond conversion by at least five percent. In another embodiment, the developed plate is heated above ambient temperature during the blanket exposure with UV energy.

In another aspect, the coating is covered by a water soluble oxygen barrier top coat, and the imaged plate is developed in a single developing tank where an aqueous developer solution is delivered at rotating brushes. The imaged plate is conveyed through the single take while in contact with the aqueous solution and brushes, thereby (i) dissolving the top coat; (ii) developing the plate by substantially completely removing only the unreacted, nonimage areas from the substrate while retaining unreacted material in the image areas to produce a developed surface, and (iii) conditioning the developed surface of the plate, all in the single tank.

In another aspect, the disclosure is directed to a method for producing a lithographic plate from a negative working, radiation imageable plate having an oleophilic resin coating that reacts to radiation by cross linking and is non-ionically adhered to a hydrophilic substrate, comprising: imagewise radiation exposing the coating to a source of violet radiation to produce an imaged plate having partially reacted image areas at an initial double bond conversion percent including unreacted coating material, and completely unreacted nonimage areas; without pre-heat, developing the plate in an aqueous solution to remove only the unreacted nonimage areas from the substrate while retaining unreacted material in the image areas; and subjecting the plate to blanket UV energy while the plate is heated above ambient temperature, thereby further reacting the retained unreacted material in the image areas and increasing the double bond conversion by at least about ten percent.

The advantages are achieved by shifting a large fraction of the cross-linking, from the imaging step to the post-treating step. Because no nonimage coating material is on the substrate after development, while the imaged areas on the substrate contain significant unreacted material, there is practically no limit to the intensity of polymerization energy that can be beneficially applied to the developed plate.

Preferably, the imaging radiation is slightly above the minimum level that provides sufficient cross-linking to prevent removal of the imaged areas during development. Post-treating is then relied on to maximize the cross-linking and thereby achieve substantially improved plate life on-press. For example, conventional infrared (IR) imaging energy is about 125 mj/cm², followed by preheating at 102° C. For a commercial implementation of the present method, imaging can be achieved at up to three or more times the speed, i.e., in the range of about 80-40 mj/cm². The percent of double bond conversion resulting from the post treatment can be greater than the percent of double bond conversion from the imaging radiation.

Imaging at this much lower energy level has another advantage beyond increased production speed. Imaging at a relatively high but common resolution of 2400 dpi at 200 lines per inch requires that each “dot” or “pixel” of imaged coating have the desired area as imaged and that the surrounding nonimaged material be cleaned out. The use of the common energy level of 125 mj/cm², can produce dot gain in which coating material surrounding the nominal area of dot exposed to the radiation, experiences residual or ancillary cross-linking at the edge of the dot, thereby degrading the resolution. At less than 100 mj/cm², especially at 70 mj/cm², resolution degradation due to dot gain is negligible, if not avoided all together.

The plates manufactured according to the presently disclosed method easily achieve in excess of 500,000 impressions on-press, which far surpasses the on-press life of conventional negative working plates developed by conventional methods. In fact, the achieved combination of high resolution and high impression capability, permit the present method to compete with lithographic printing using positive working plates.

With violet imaging at 40-60 μJ/cm² (which is a practical range in the industry), there is generally insufficient cross linking of material in the imaged areas of the coating for the subsequently developed plate to be effective as a printing plate. Post treatment of the same imaged plate with UV blanket exposure at 250 mJ/cm² after development, produces additional cross linking, and effective plates, but when combined with elevated temperature the UV exposure becomes much more effective.

This combination of imaging with violet radiation (in the range of 400-450 nm) and post treating with UV radiation (450-750 nm) is possible because the coating has a bandwidth of sensitivity outside of the peak or maximum. Thus, a coating formulated for maximum sensitivity to a particular wavelength of a violet imaging laser will have enough sensitivity to a relatively high total blanket exposure of a spectrum of UV wavelengths. Since all the unimaged coating material was removed from the substrate during the development step before post-treatment, no such material remains to be subject to unwanted cross-linking adjacent the desired image dots. Combined thermal and UV post-treatment is then relied on to maximize the cross-linking and thereby achieve improved plate life on-press.

### BRIEF DESCRIPTION OF THE DRAWING

FIG. 1 schematically shows a printing system comprising plate stack, imager, and press;

FIG. 2 is a schematic plate cross section showing an imageable coating directly supported on a substrate;

FIG. 3 is a schematic plate cross section showing an imageable plate with a subcoat and top coat;

FIG. 4 is a schematic plate cross section upon exposure to radiation;

FIG. 5 is a schematic plate cross section showing the pattern of remaining oleophilic imaged areas of the coating and the hydrophilic substrate surface areas where the unimaged areas have been removed in solidus;

FIG. 6 is a schematic of one embodiment of a pre-press water processor; and

FIG. 7 is a schematic of another embodiment of a pre-press water processor.

### DESCRIPTION OF THE PREFERRED EMBODIMENTS

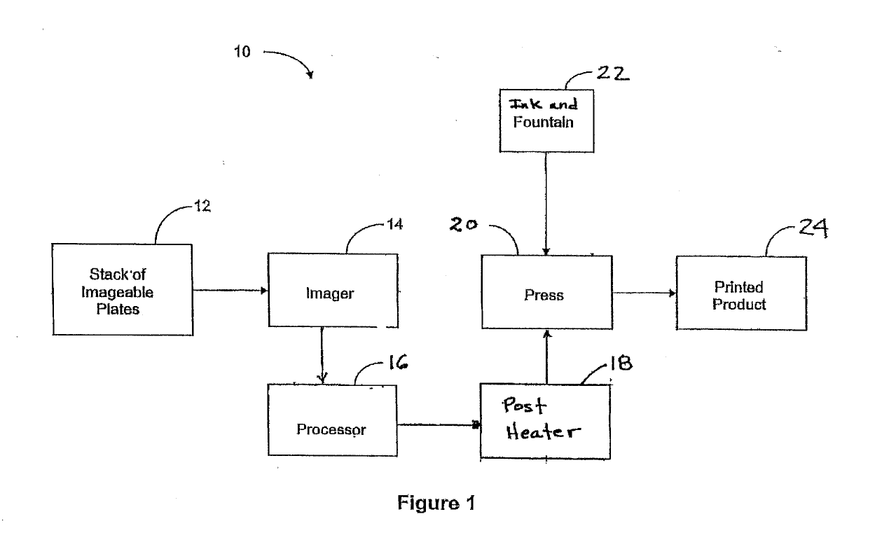

FIG. 1 shows a schematic of a printing plant 10, such as for newspaper printing, in which a stack of radiation imageable plates 12 is situated upstream of an imager 14, where the coating on the plates is selectively cross linked by selective exposure to radiation to form a pattern of highly cohesive and adhesive areas, and areas that exhibit less cohesion and adhesion. The plate substrate is hydrophilic, whereas the coating is oleophilic. The radiation exposure produces high internal cohesion, and high adhesion to the plate. In a conventional negative working system, the original (unimaged) coating is soluble in a specified developer solvent, so the imaged plate must be developed with such solvent to remove the non-exposed areas and thus produce a plate usable in the press. The developer solutions most frequently used contain either some amount of an organic solvent (typically benzyl alcohol) or have an elevated pH (alkaline).

In one embodiment, the imaged plates are transferred to a mechanical processor 16, in which the non-imaged areas are removed by mechanical impingement of the coating with resulting dislodgment and removal. The energy level of the imaging at 14 is selected such that the imaged areas are only partially reacted, i.e., the imaged plate has partially reacted image areas including unreacted coating material, whereas the non-image areas are completely unreacted, i.e., they have not been affected by the radiation. The mechanical impingement removes only the unreacted non-image areas from the substrate while retaining all of the unreacted material in the image areas. The mechanically developed plates are then delivered to a post-treatment unit 18 where blanket exposure of the plate from an external source of energy further reacts the image areas, thereby increasing the cross linking within the image areas.

The fully developed plates are then mounted on press 20 where the ink 22 develops the plates and produces printed product 24.

Tables A and B show data that was obtained for IR imaging with thermal post treatment by varying the imaging energy, the blanket heating energy temperature after imaging, and the rate of travel of the plate at a given temperature.

TABLE A

| | BLANKET | | | AVG. COLOR |
|---|---|---|---|---|
| PLATE | IR | POST HEAT | POST HEAT | VALUE |
| # | (mj/cm2) | TEMP (° C.) | RATE (ft/min) | LOSS (%) |
| 1 | 50 | 160 | 4 | 21 |
| 2 | 50 | None | None | 74 |

TABLE B

| | | | | COLOR | |
|---|---|---|---|---|---|
| | BLANKET | | POST | VALUE | PLATE |
| PLATE | IR | PRE HEAT | HEAT | LOSS | AVG |
| # | (mj/cm2) | TEMP (° C.) | TEMP (° C.) | (%) | LOSS |
| 3 | 100 | NONE | NONE | 33 | |
| | 120 | NONE | NONE | 28 | |
| | 140 | NONE | NONE | 23 | |
| | 160 | NONE | NONE | 21 | |
| | | | | | 26 |
| 4 | 100 | 105 | NONE | 32 | |
| | 120 | 105 | NONE | 18 | |
| | 140 | 105 | NONE | 11 | |
| | 160 | 105 | NONE | 9 | |
| | | | | | 17 |
| 5 | 100 | NONE | 160 | 9 | |
| | 120 | NONE | 160 | 6 | |
| | 140 | NONE | 160 | 6 | |
| | 160 | NONE | 160 | 5 | 6 |

In Table A, both samples were imaged at 50 mj/cm², one with post-heating at 160° at a throughput of 4 feet per minute, whereas the other was not post-heated. The plates as imaged and post-heated were rubbed with a cotton swab with benzyl alcohol for 100 double rubs. For imaging at a dot density of 80, 90 and 100, the average percent color value loss for the post-heated plate was 21% whereas the average loss for the non-post heated plate was 74%. Table A shows that post heating increases durability significantly relative to no post-heating for plates that were imaged at low energy and developed in an aqueous solution.

Table B shows that at the relatively low heating temperature (105° C.) used in conventional preheat of negative working plates, the higher the imaging energy level the lower the color value loss (Plate #4). The improvement in the average color change relative to no pre or post heating (Plate #3) only went from 26% without post-heat to 17% with post-heat over the range of 100-160 mj/cm². However, with a post-heat temperature of 160° (Plate #5), the average percent loss over the same energy exposure range is only 6%. Moreover, energy of only 100 mj/cm² and 160° post heat temperature produces the same loss as energy exposure of 160 mj/cm², at 105° preheat temperature (i.e., 9%).

The conclusion to be drawn is that the capability of post-heating at high temperature produces significantly enhanced cross-linking. The average at 160° post-heat verses no post-heating is a four-fold improvement from 26% loss to 6% loss. Relative to post-heating at conventional temperature of 105°, post heating at 160° shows approximately a three-fold improvement, from 17% to 6% loss.

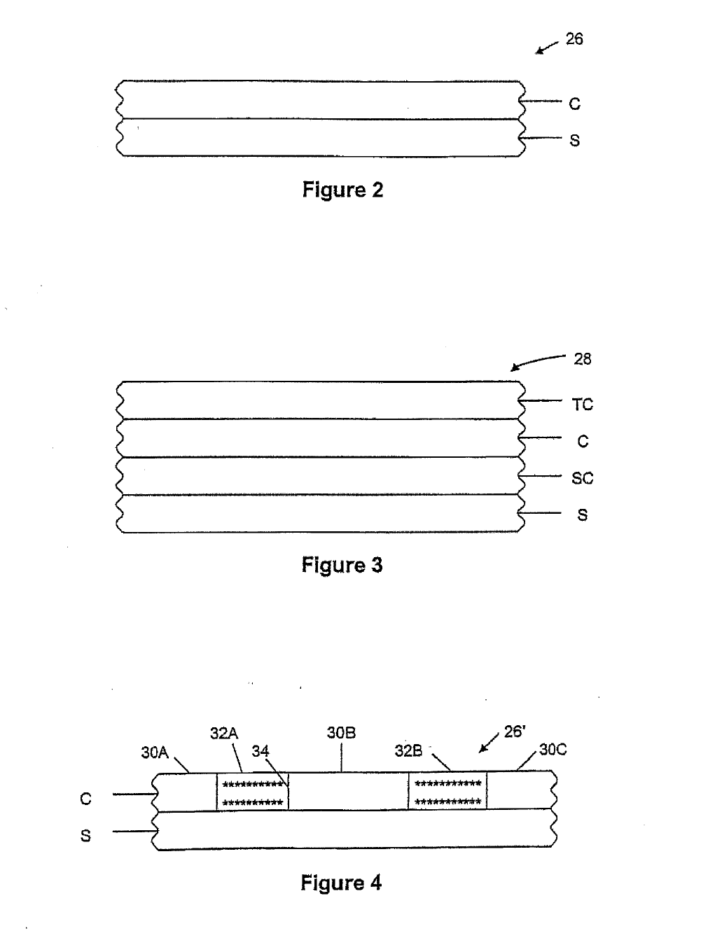

FIGS. 2-5 illustrate schematically, the physical attributes of a plate according to an aspect of the present invention. FIG. 2 is a schematic section view of the basic embodiment 26, consisting of a substrate or carrier S on which an organic, non-aqueous solvent-based coating C has been applied and dried. The substrate S is preferably a grained, anodized aluminum sheet. The substrate is preferably treated with a hydrophilizing agent prior to coating. Such treatments are well known in the art, and include silicate solutions, polyvinylphosphonic acid (PVPA) or amino trimethylenephosphonic acid (ATMPA). The coating C is applied from a solvent soluble composition comprising one or more components capable of cross linking by free radical polymerization. The polymerization arises as a result of imaging with ultraviolet, visible or infrared radiation. As such, the coating may further comprise radiation absorbers and/or initiators to facilitate the cross linking efficiency. None of these active components is soluble in water. Preferred coating compositions further comprise a polymeric binder material to enhance the oleophilicity and durability of the coating in the ink receptive printing areas.

FIG. 3 is a schematic section view of a plate according to an alternative embodiment where a subcoat SC has been applied to the substrate S, the imageable coating C is applied over the subcoat, and a topcoat TC is applied over the imageable coating. The top coat TC is typically a water soluble film forming layer such as polyvinyl alcohol (PVOH) that serves to prevent atmospheric oxygen from diffusing into the coating and quenching the free radicals. Without the topcoat, the polymerization efficiency is dramatically decreased. The subcoat SC is a water soluble material that facilitates the release of the coating from the substrate in the unimaged areas. The subcoat SC must not adversely impact the adhesion of the coating to the substrate in the imaged areas of the coating. 4-hydroxybenzene sulfonic acid, sodium salt has been found to be particularly suitable as a subcoat.

FIG. 4 corresponds to FIG. 2, and illustrates the effect on the coating of exposure to imaging radiation. The radiation source is preferably a digitally controlled laser, which produces exposure pixels such that a pattern of unexposed coating 38a, 30b, and 30c and exposed coating 32a and 32b covers substantially all of the plate. However, any of the sources of incident imaging radiation used in the art to form selectively written surfaces can be used. The selective imaging results in relatively distinct boundaries 34 at the interface between the imaged and unimaged areas. For the illustrated negative working plate, the exposed coating in areas 32a, 32b becomes highly but still only partially cross linked, thereby creating areas that have sufficient cohesion and adhesion such that they are not removable by the development step. The unexposed areas 30a, 30b, and 30c retain the original characteristics and properties of the dried coating before imaging. This material is not highly cross linked, and lacks the adhesion to withstand substantial development process.

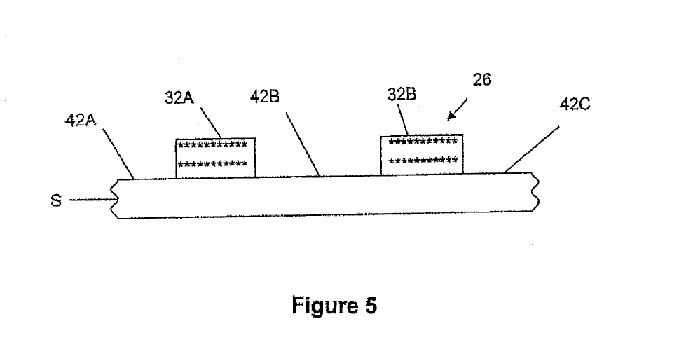

FIG. 5 shows a portion of the resulting plate 26 ready for post-treatment with areas 32a and 32b representing the partially reacted oleophilic coating areas and 42a, 42b, and 42c representing the hydrophilic substrate surfaces. It is to be understood that the plates and process described with reference to all figures herein are essentially planographic and, the relative thickness of the areas and surfaces shown in the figures should not be considered as in scale.

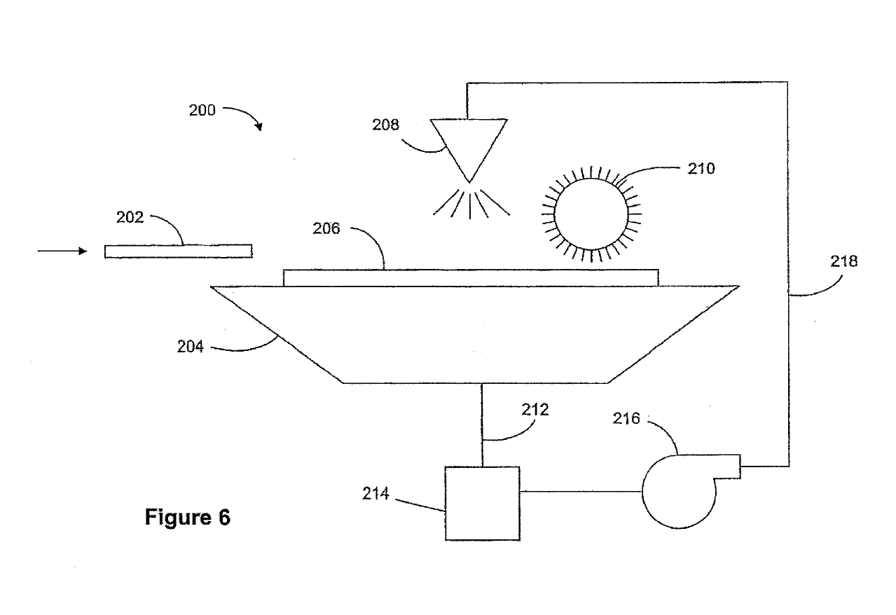

FIG. 6 is a schematic of the operative components of one possible processor 200 for pre-press development—in this case, mechanical development—of an imaged plate in a system as depicted in FIG. 1 (where the processor is indicated at 16). The imaged plate 202 is conveyed over a basin or tank 204 onto a platen 206 or the like. Water, but preferably an aqueous wash fluid, is sprayed or otherwise deposited 208 on or near a coarse rotary brush 210 which impinges on the coating surface to dislodge and remove the unimaged areas as particulates. The overflowing fluid with removed particles is captured in the basin or sump 204 and continuously drained and delivered via line 212 to particle filter 214. The filtered fluid is recirculated back to the spray nozzle 218 by pump 216 and return line 218. The resinous material removed as particles is trapped in the filter, so there is little or no chemical treatment required of the waste stream associated with developing the plate.

A significant advantage of the present invention is that the integrity of the imaged coating is not adversely affected by the developing fluid. For conventional plates, the imaging process causes a change in the solubility of the coating in the developer. The change is never 100% efficient; that is, even the imaged coating will often have some level of solubility in the developer. This residual solubility may significantly alter the adhesive and/or cohesive integrity of the coating. Mechanical development does not suffer from this problem. The coating weight of the imaged areas is not affected by such development.

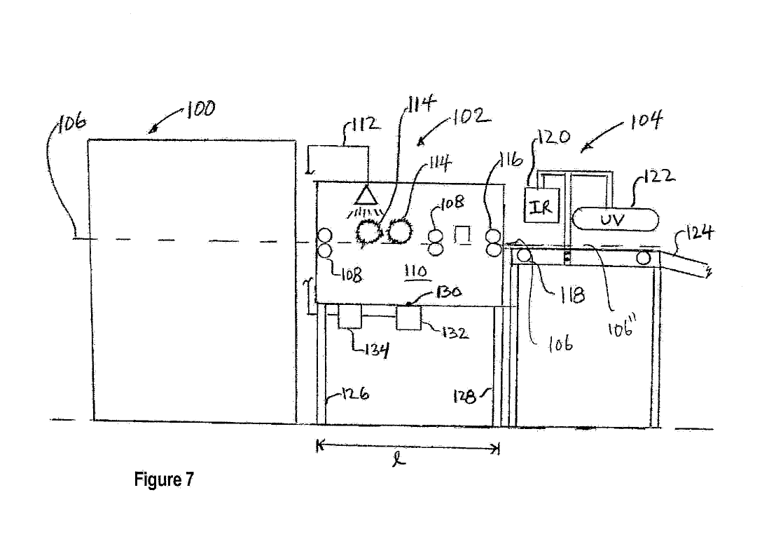

FIG. 7 is a schematic of the operative components of a representative system for implementing another aspect of the invention, comprising an exposure unit 100, a developing wash out section 102 and a post treatment section 104. An imaged plate having partially cross-linked image areas and nonimage (non-cross linked) areas follows process path 106 to upstream conveying rollers 108 and is thereby conveyed through a tank 110 where the plate is subjected to a developing solution or washout solution 112 and heavy brushes 114. The brushes remove the non-image areas from plate while the active ingredients for cross-linking remain intact in the image areas on the plate. The developed plate emerges at 106′ from discharge rollers 116 for entering the post treatment station 104, onto an endless belt conveyor 118. The plate is guided at 106″, under a heater 120 such as an IR lamp which dries and heats the plate. The plate is continuously conveyed under the immediately adjacent UV lamp 122. The dual or combined post treatment further cross-links the image areas, thereby producing a finished plate that emerges onto ramp 124 for stacking.

Although the hardware for implementing the invention can take a variety of forms, it is represented in the figure as elevated on front and rear legs 126, 128 with room between the legs for components to circulate and filter the wash out solution 112. These are shown schematically as a drain conduit 130 leading to a pump 132 which is supported as beneath the tank. The pump delivers flow to a filter 134 which is likewise supported, with the filtered solution returned to spray bar 112 on line 136.

Removal of the nonimage areas of the coating in the aqueous developing fluid is assisted or entirely accomplished by the brushes 114. Any combination of brushes and developer solution that retains at least 98% of the coating weight of the image areas while removing at least 98% of the nonimage areas from the plate is preferable. Notably, while development by mechanical removal of nonimaged areas described herein is one preferred embodiment, the invention is not limited as such. Embodiments exist wherein other techniques, such as solubilization and/or dissolution for example, participate in the removal of non-imaged areas.

When imaging is performed at a relatively low energy, e.g., below 100 mj/cm², mechanical development can clean out non-imaged material to a level approaching 100%, because less than about 50% of the ultimate (post heat) cross linking can be performed during imaging. Even relatively coarse brushes with flushing water can remove unimaged material at the edges of the dots and, furthermore, there is little if any undesirable cross linking of coating material immediately surrounding the nominally exposed pixel due to avoidance of the dot gain effect.

In one particular embodiment of the invention having a basic configuration shown in FIG. 2, the coating comprises from about 5 to about 30 wt % based on solids content, of a polymer that is generally considered by practitioners of applied chemistry, as insoluble in water. The polymer material may be selected from a wide range of types such as but not limited to acrylates (especially urethane acylates), siloxanes, and styrene maleic anhydrides.

The coating may comprise from about 35 to about 75 wt % based on solids content, of a polymerizable monomer, a polymerizable oligomer, or combination thereof that is similarly insoluble in water. Some suitable radically polymerizable (cross linkable) materials are a multifunctional acrylate such as Sartomer 399 and Sartomer 295 commercially available from Sartomer Co.

The coating comprises a non-water-soluble initiator system capable of initiating a polymerization reaction upon exposure to imaging radiation. Some suitable initiator systems comprise a free radical generator such as a triazine or an onium salt.

An embodiment of the coating includes from about 5 to about 15 wt % based on solids content of an organic compound that is soluble in organic solvents and only partially soluble in water. Some suitable compounds include a substituted aromatic compound, such as DTTDA (an allyl amide derived from tartaric acid) and tetra methyl tartaramide. In the mechanical removal embodiment, the water solubility must not be so great as to overcome the hardening of the imaged areas and compromise the ability of these areas to remain on the plate without loss of active ingredients.

Additional optional components include dyes that absorb the imaging radiation (e.g. infrared absorbing dyes) and pigments or dyes that serve as colorants in the coating.

There are many types of resins, oligomers and monomers that can be used to produce coatings that would have properties suitable for use in the present invention. It is believed that the monomer to polymer ratio in the range of 2-4 and the use of an organo-borate catalyst with an onium salt catalyst are important preferences. A wide mixture of functionalities can be used but dried coatings with better adhesion and cohesion are achieved with multi-functional monomers and oligomers (functionality of 3 or higher). It is not necessary to use a resin which contains unsaturated groups but in the majority of the cases the cured film will exhibit better adhesion and integrity. Types of resins can include poly vinyls (poly vinyl acetate, poly vinyl butyral, etc.), cellulosic, epoxies, acrylics and others as long as the resin does not produce a strong adhesive bond with the substrate. Monomers and oligomers should be somewhat viscous liquids and can be polyester/polyether, epoxy, urethane acrylates or methacrylates (such as polyether acrylate, polyester acrylate, modified epoxy acrylate, aliphatic urethane methacrylate, aliphatic urethane acrylate oligomers, polyester acrylate oligomers, aromatic urethane acrylate, dipentaerythritol pentaacrylate, pentaacrylate ester, etc.).

TABLE C
Radiation Sensitive Coatings

| | Formulations | | |
|---|---|---|---|
| Ingredients | #1 | #2 | #3 |
| PGME | 94.990 | 94.990 | 94.990 |
| Poly 123 | 1.500 | — | — |
| Bayhydrol 2280 | — | 1.500 | — |
| ACA Z250 | — | — | 1.500 |
| Sartomer 399 | 1.750 | 1.500 | 2.000 |
| Sartomer 454 | 0.250 | 0.250 | — |
| Sartomer 355 | — | 0.250 | — |
| IRT thermal Dye | 0.150 | 0.150 | 0.150 |
| Penn Color | 0.350 | 0.350 | 0.350 |
| HOINPO2 | 0.400 | 0.350 | 0.050 |
| Showa-Denko P3B | — | 0.050 | 0.350 |
| Phenothiazine | 0.010 | 0.010 | 0.010 |
| Showa-Denko 2074 | 0.600 | 0.600 | 0.600 |
| TOTAL | 100.00 | 100.00 | 100.00 |

With reference to Table C, formulations #1-3 are consistent with a preferred implementation of the present invention, to the effect that a wide range of ingredients can be used in order to produce a lithographic printing plate that can be developed using the described technique.

All plates having coating formulations #1-3 are comprised of a substrate with a hydrophilic surface and a very oleophilic radiation sensitive layer, but the mode of development of coating formulations #1-3 relies strictly on the adhesive and cohesive properties of the coating. These coatings as applied and prior to imaging exposure have better cohesive strength than adhesive strength. When the coating is exposed to radiation it undergoes polymerization which greatly amplifies its adhesive and cohesive strengths.

The following list of representative ingredients will enable practitioners in this field to formulate coating compositions that are adapted to a meet targeted performance that balance cost of ingredients, coating process control, shelf life, range of imaging radiation wavelength, type or types of mechanical forces to be used for development, type of fountain and ink on press, and ease of achieving target resolution. For commercial purposes additional, non-active water insoluble ingredients can be included such as viscosity agents for facilitating coating of the plate, shelf life stabilizers, and agents for reducing any tendency for removed coating particles to build up in, e.g., a water and rotary brush processor. In variations not shown in Table D, the solvent can be Arcosolve PM, DMF, and MEK; non-active stabilizers, pigments and the like can include Karenz PE1 and 29S1657 as well as the ACA Z 250. Urethane acrylate resins with active ingredients similar to formulation #2 and various water-insoluble inactive ingredients are presently preferred.

A satisfactory prototype coating is shown in Table D.

TABLE D

| COMPONENT | % BY WEIGHT |
|---|---|
| Arcosolv PM⁽¹⁾ | 78.0347 |
| DMF⁽¹⁾ | 6.8159 |
| MEK⁽¹⁾ | |
| 1% Ciba Geigy UV-10 in DMF⁽²⁾ | 0.1900 |
| Showa Denko P3B⁽³⁾ | 0.0650 |
| HOINTPO2⁽⁴⁾ | 0.1500 |
| IRT Thermal Dye⁽⁵⁾ | 0.1152 |
| Secant/Rhodia 2074⁽⁶⁾ | 0.4116 |
| 40% SR-399 in PM⁽⁷⁾ | 07.2145 |
| 29S1657⁽⁸⁾ | 4.6132 |
| Bayhydrol 2280⁽⁹⁾ | 2.3900 |
| Total | 100.0000 |

⁽¹⁾Solvent
⁽²⁾Stabilizer
⁽³⁾Initiator
⁽⁴⁾Initiator
⁽⁵⁾IR absorbing dye
⁽⁶⁾Initiator
⁽⁷⁾Monomer
⁽⁸⁾Pigment dispersion
⁽⁹⁾Polymer Binder (Resin)

Only a partial cross-linking of the photosensitive layer is desired during the imaging step with the balance of cross-linking occurring during post treatment. With thermal post treatment, the effects of cross linking can sometimes be enhanced if the temperature exceeds the glass transition temperature of particles of resin that may not have dissolved in the monomer. If such particles are closely enough distributed in the matrix they can fuse with one another, creating a network or web which further enhances the strength of the oleophilic areas that will perform the print image on press. Because if such fusion occurs it would only be in the image areas after the non-image areas have been removed, the fusion would not increase the dot or pixel size.

Development is preferably achieved with relatively stiff, coarse, rotating brushes in an aqueous environment such as in the Agfa Azura wash out unit or the Proteck XPH 85 HD processor. Both machines use two relatively stiff, coarse brushes supported by a platen and have spray bars that deliver an aqueous wash out solution to the plate. The wash out solution is allowed to flow over the plate and then run back into the sump that is located below the machines. The solution is kept at about 70-100° F. in the sump. The basic wash out solution contains water soluble resins, anionic surfactants, nonionic surfactants and silica, and may optionally include a gum or equivalent. The components of the wash out solution should be selected to serve three basic purposes. First, they help prevent the particles of coating that are removed by the brushes from sticking to each other or any surfaces that they encounter. Second, they serve as a finisher on the plates to protect against fingerprints and heat. Third, they increase the hydrophilicity of the substrate.

The described development technique for plates IR imaged above 100 mj/cm² with brushes and this basic wash out solution will clean out up to about 97% or 98% of unimaged material, which is quite adequate for newspaper printing. However, if the plates are to be used for commercial or other high quality jobs, cleanout should approach 100% before post heating.

To achieve this level of cleanout, residual unimaged material at the base of the image dots can be removed by the action of one or two additional, nonionic surfactants that have high HLB values. As a practical matter, the surfactant molecule has one end that has an affinity to water and another end that has an affinity to the oleophilic coating, so the action of the brushes and water turbulence may remove the residual coating as if by pulling it off the substrate.

Increased cleanout can also be achieved with only brushes and tap water if the brush impact duration is extended by decreasing the throughput rate.

If the coating includes a water soluble or partially water soluble compound, the water removes at least some of the unimaged coating by solubilization and/or penetrates the unimaged coating to the substrate whereby the coating separates from the substrate in particulate form with less mechanical action than in the earlier-described embodiment or even without mechanical forces at all (i.e., via dissolution or solubilization). As in all embodiments, the imaged areas have been exposed to sufficient energy to enhance the adhesion to the substrate and the internal cohesion and thereby resist removal during development. This enhancement in the image areas minimizes the penetration of water due to the presence of the partially water soluble compound. Even if some of the material in the image areas is lost during development, enough partially cross linked material remains such that the additional cross linking reactions during post treatment with energy provide the desired advantages.

Table E shows that over a wide range of IR imaging energy, the hardening of the imaged areas is predominantly dependent on the post treatment energy (via heat). Even without the UV, one can obtain the advantage of imaging at a low energy/high speed (e.g. 40 to 80-mj), while easily achieving higher durability using post heat temperatures (e.g., 160° C.) well above the practical pre-heat limit of 105° C. The Table E shows that 40 mj imaging with 160° C. post heat produces higher cross linking (50% vs. 40%) and much more plate life (1.76% vs. 5.08% color loss) than imaging at 200 mj without pre or post heat. The table also shows that initial radiation imaging at 40 mj or 80 mj, produces 16% and 24% cross linking, respectively. Post heating increases the cross linking to 50% and 52% respectively. As will be shown below, an even higher per cent cross linking can be achieved at a lower post-treatment temperature when combined with another source of energy, in this case UV blanket exposure.

### Table E

TABLE E

| | IR IMAGING INTENSITY | | | | |
|---|---|---|---|---|---|
| | 200 mj | 160 mj | 120 mj | 80 mj | 40 mj |
| Post Heat @160 C. | | | | | |
| % Color Loss | 0.04 | 0.67 | 1.02 | 1.37 | 1.76 |
| % Cross Linked | 56 | 55 | 55 | 52 | 50 |
| No Pre or Post Heat | | | | | |
| % Color Loss | 5.08 | 6.76 | 9.23 | 13.93 | 31.72 |
| % Cross Linked | 40 | 40 | 35 | 24 | 16 |

The following Table F shows that imaging with low energy and high post heating temperature also achieves higher resolution.

TABLE F

| | MEASURED RESOLUTION @ 2400 dpi (%) | | | | | |
|---|---|---|---|---|---|---|
| IR ENERGY (mj) | 200 | 200 | 200 | 40 | 40 | 40 |
| HEATING | NONE | PRE | POST | NONE | PRE | POST |
| TEMP (° C.) | NONE | 105 | 160 | NONE | 105 | 160 |
| TARGET % | | | | | | |
| RESOLUTION | | | | | | |
| @2400 dpi | | | | | | |
| 1 | 2.2 | 2.1 | 2.3 | 1.2 | 1.3 | 1.0 |
| 2 | 3.9 | 4.3 | 4.5 | 2.3 | 2.8 | 2.2 |
| 3 | 6.6 | 8.7 | 6.4 | 3.3 | 4.1 | 3.7 |
| 4 | 8.4 | 10.0 | 9.3 | 5.4 | 6.8 | 5.8 |
| 5 | 11.8 | 11.9 | 10.5 | 6.2 | 7.9 | 6.4 |
| 10 | 18.4 | 22.5 | 18.7 | 11.6 | 13.6 | 11.3 |
| 30 | 41.8 | 72.3 | 62.6 | 33.7 | 35.1 | 31.8 |
| 80 | 97.3 | 99.4 | 99.1 | 80.7 | 83.2 | 81.1 |
| 90 | 99.3 | 100 | 99.7 | 90.2 | 92.0 | 90.5 |
| 95 | 100 | 100 | 100 | 94.7 | 95.4 | 94.3 |
| 96 | 100 | 100 | 100 | 95.7 | 95.7 | 95.7 |
| 97 | 100 | 100 | 100 | 96.0 | 96.9 | 96.7 |
| 98 | 100 | 100 | 100 | 97.4 | 98.0 | 97.7 |
| 99 | 100 | 100 | 100 | 98.5 | 98.5 | 98.5 |
| 100 | 100 | 100 | 100 | 100 | 100 | 100 |

With imaging at 200 mj the measured resolution matches the target resolution to commercially acceptable standards, whether or not the plate is pre or post heated. Such high imaging energy polymerizes coating material outside the footprint of radiation as it penetrates the coating, producing unwanted hardening outside the desired pixel boundary. With imaging at 40 mj, and no pre or post heating, the resolution is within commercially acceptable standards, but as discussed, the plate would have unacceptably low life on press. With the know method of imaging at 40 mj after pre heat at 105° C., the resolution is still acceptable and the plate life would be improved relative to no heating, but still not up to commercial standards. With imaging at 40 mj and post heating at 160° C., the resolution is overall at least as good, if not better than with either no heating or pre heating.

The following Tables G-J demonstrate either the amount of double bond conversion and/or the resolution of the images when exposed to the various types and amounts of energies. In all examples, the plates were exposed to imaging radiation, developed in an aqueous wash out solution with rotating brushes in an aqueous wash out solution, as described above, and then post-treated as described in the relevant Table entry.

TABLE G
IR Imaging With Aqueous Development
(Varied Post Exposure Treatments for % conversion)
(All exposures done at 130 MJ)

| | |
|---|---|
| Exposure only | 36% conversion |
| Exposure + Pre Heat | 44% conversion (+22%) |
| Exposure + UV Post Cure | 46% conversion (+28%) |
| Exposure + IR Post Cure | 54% conversion (+50%) |
| Exposure + UV + IR Post Cure | 66% conversion (+83%) |

The numbers in parentheses show the per cent increase in double bond conversion with pre-heat or post treatment, relative to the conversion due to imaging exposure only. Whereas preheating improves the conversion by 22%, all the post-treatment techniques improve the conversion by at least 28% (with UV only) up to 83% (with a combination of UV on an IR heated). Stated differently, at least 20% and up to 45% of the final double bond conversion is achieved in the post-treatment step. IR post-treatment alone achieves over 30% of the total conversion.

TABLE H
IR Imaging With Aqueous Development and UV + IR Post Cure
(Varied exposures for % conversion)

| | | |
|---|---|---|
| 30 | MJ | Exposure too low to obtain reading |
| 50 | MJ | Exposure too low to obtain reading |
| 70 | MJ | 66.5% conversion |
| 90 | MJ | 65.7% conversion |
| 110 | MJ | 68.3% conversion |
| 130 | MJ | 67.0% conversion |
| 150 | MJ | 65.3% conversion |
| 170 | MJ | 67.5% conversion |
| 190 | MJ | 68.0% conversion |

TABLE J
IR Imaging with Aqueous Development and UV + IR Post Cure
(Varied exposures for resolution measurements @ 175 lpi/2400 dpi)

| | | | | |
|---|---|---|---|---|
| Exposure | 1 pixel | 2 pixel | 3 pixel | 4 pixel |

| | | | | | |
|---|---|---|---|---|---|
| 30 | MJ | N/A | N/A | N/A | N/A |
| 50 | MJ | N/A | N/A | N/A | N/A |
| 70 | MJ | 93% | 61% | 57% | 55% |
| 90 | MJ | 97% | 68% | 60% | 58% |
| 110 | MJ | 99% | 75% | 67% | 60% |
| 130 | MJ | 100% | 76% | 68% | 61% |
| 150 | MJ | 100% | 78% | 69% | 62% |
| 170 | MJ | 100% | 81% | 73% | 66% |
| 190 | MJ | 100% | 99% | 93% | 90% |

The following Examples were undertaken for plates having a coating sensitive to violet imaging, development with strong brushes and an aqueous solution, and UV post treatment.

O-CI-HABI: 2.2′-bis(2-chlorophenyl)-4,4′,5,5′-tetraphenyl 1,1′-biimidazole, CAS7189-82-4, available from Hampford Research, Stratford, Conn.

Ethyl Michler's Ketone: 4,4-Bis(diethylamino)benzophenone, CAS90-93-7, available from Signa-Aldrich, Milwaukee, Wis.

N-Phenylglycine: CAS 103-01-5. available from Sigma-Aldrich, Milwaukee, Wis.

Joncryl HPD 671: A high molecular weight styrene acrylic resin available from BASF Corporation, Florham Park, N.J.

Binder A: A 33% by weight solution of acrylic resin in 2-butanone, supplied by ZA Chemicals, Wiesbaden, Germany.

Cyclomer Z250: A 45% by weight solution of acrylic resin in diprophylene glycol methyl ether, supplied by Cytec Surface Specialties Inc., Smyrna, Ga.

BYK 344: A silicone surface additive supplied by BYK USA Inc., Wallingford, Conn.

29S1657: A pigment dispersion comprising phthalocyanine blue 15-4, (59.5 parts), Cyclomer Z250, (87.8 parts), BYK344 (1 part), 1-methoxy-2propanol, (251.7 parts), prepared by Penn Color, Doylestown, Pa.

SR399: Dispentaerythritol pentaacrylate, available from Sartomer, Exton, Pa.

FST510: A preparation of >82% Diurethanedimethacrylate in 2-butanone, as supplied by AZ Chemicals, Weisbaden, Germany.

Selvol 107: A 10% by weight solution of polyvinylalcohol in water, as supplied by Sekisui America, Mount Laurel, N.J.

Selvol 205: A 21% by weight solution of polyvinylalcohol in water, as supplied by Sekisui America, Mount Laurel, N.J.

Capstone FS-30: A 25% solution by weight of an ethoxylated nonionic fluorosurfactant in water, as supplied by DuPont, Wilmington, Del.

Substrate A: 0.012″×12′×19′ aluminum sheet that has been electro-grained, anodized and post-treated with sodium meta silicate.

Verti Wash: A non-solvent based processing fluid having a slightly alkaline pH, as supplied by Anocoil Corporation, Rockville, Conn.

N200 developer: A conventional subtractive developer, as supplied by Anocoil Corporation, Rockville, Conn.

NES Opal 850: A cleanout unit used to process and gum plates in a single step, as supplied by NES Worldwide Inc., Westfield, Mass.

Protek XPH85: A conventional plate processor as supplied by Proteck, Sholinganallur, India.

ECRM Mako 4: A violet computer-to-plate setter as supplied by ECRM, Tewksbury, Mass.

UV Light Frame: As supplied by Thiemer Gmbh, Birstein, Germany, using a THS3007 UV bulb for a time and intensity sufficient to produce radiation of 250 mJ/cm², measure using a photometer supplied by International Light of Newburyport, Mass.

Polymerization test: A Prematek flat cloth, as supplied by CCP Industries, Cleveland, Ohio is impregnated with benzyl alcohol. The image on the plate is given 60 hard rubs. The plate is rated on a scale of 1 to 10. If the solvent does not attach the image, the plate receives a score of 10. If the image is completely removed by the solvent, the plate receives a score of 1. Generally plates receiving a score less than 7 do not print with good durability in real world situations.

Coating Solutions

| | Coating A | Coating B |
|---|---|---|
| Component | Amount (g) | Amount (g) |
| 1-methoxy-2-propanol | 261.58 | 261.58 |
| 2-butanone | 175.00 | 165.54 |
| Dimethylformamide | 28.26 | 28.26 |
| o-cl-HABI | 0.81 | 0.81 |
| Ethyl Michler's Ketone | 1.20 | 1.20 |
| N-phenylglycine | 0.93 | 0.93 |
| Joncryl HPD 671 | 4.66 | |
| Binder A | | 14.12 |
| 29S1657 | 13.52 | 13.52 |
| SR399 | 9.30 | 9.30 |
| FST510 | 4.69 | 4.69 |
| BYK344 | 0.05 | 0.05 |
| Total | 500.00 | 500.00 |

Topcoat A:

| | Topcoat A |
|---|---|
| Component | Amount (g) |
| Selvol 107 | 122.50 |
| Selvol 205 | 59.52 |
| FS-30 | 1.00 |
| Propan-2-ol | 20.00 |
| water | 196.98 |

Coatings A and B were applied to Substrate A with a 0.0012″ wire-wound bar. The resulting plates were dried in an oven at 90° C. for 120 sec. The weight of the dry coating was approximately 1.0 g/m².

Topcoat A was applied to both coatings A and B with a 0.008″ wire-wound bar. The topcoat was dried for 120 sec at 90° C. The weight of the dry topcoat was approximately 0.80 g/m².

The resulting plates were exposed to violet radiation with a test pattern using an ECRM Mako4 set to 100 mW laser power (approximately 62 μJ/cm² exposure on coating).

### Example 1

After laser exposure, a plate comprising Coating A was processed through an NES Opal processing unit containing Verti gum at 72° F. The processing speed was set at 2 feet per minute. Any coating not addressed by the laser was easily removed by the gum and brushes to produce a high definition image. This plate received a score of 4 for the polymerization test.

### Example 2

After laser exposure, a plate comprising Coating B was processed through an NES Opal processing unit containing Verti wash at 72° F. The processing speed was set at 2 feet per minute. Any coating not addressed by the laser was easily removed by the wash and brushes to produce a high definition image. This plate received a score of 2 for the polymerization test.

### Example 3

After laser exposure, a plate comprising Coating A was processed through an NES Opal processing unit containing Verti wash at 72° F. The processing speed was set at 2 feet per minute. Any coating not addressed by the laser was easily removed by the gum and brushes to produce a high definition image. The plate was the subject to 250 mJ/cm² post development UV exposure. This plate received a score of 10 for the polymerization test.

### Example 4

After laser exposure, a plate comprising Coating B was processed through a NES Opal processing unit containing Verti gum at 72° F. The processing speed was set at 2 feet per minute. Any coating not addressed by the laser was easily removed by the Verti wash and brushes to produce a high definition image. The plate was then subject to the 250 mJ/cm² post development UV exposure. This plate received a score of 10 for the polymerization test.

### Example 5

After laser exposure, a plate comprising Coating A was pre-heated at 105° C. for 40 seconds, then processed through a NES Opal processing unit containing Verti wash 72° F. The processing speed was set at 2 feet per minute. Any coating not addressed by the laser was easily removed by the wash and brushes to produce a high definition image. This plate received a score of 7 for the polymerization test.

### Example 6

After laser exposure, a plate comprising Coating A was pre-heated at 105° C. for 40 seconds, then processed through a NES Opal processing unit containing Verti wash at 72° F. The processing speed was set at 2 feet per minute. Any coating not addressed by the laser was easily removed by the wash and brushes to produce a high definition image. The plate was then subject to the 250 mJ/cm² post development UV exposure. This plate received a score of 10 for the polymerization test.

### Example 7

After laser exposure, a plate comprising Coating A was processed through a Protek XPH85 processor containing N200 developer at 78° F. The processing speed was set at 4 feet per minute. Any coating not addressed by the laser was easily removed by the developer to produce a high definition image. This plate received a score of 4 or the polymerization test.

### Example 8

After laser exposure, a plate comprising Coating A was processed through a Protek XPH85 processor containing N200 developer at 78° F. The processing speed was set at 4 feet per minute. Any coating not addressed by the laser was easily removed by the developer to produce a high definition image. The plate was then subject to 250 mJ/cm² post development UV exposure. This plate received a score of 4 for the polymerization test.

### Example 9

After laser exposure, a plate comprising Coating A was pre-heated at 105° C. for 40 seconds, then processed through a Protek XPH85 processor containing N200 developer at 78° F. The processing speed was set at 4 feet per minute. Any coating not addressed by the laser was easily removed by the developer to produce a high definition image. This plate received a score of 6 for the polymerization test.

### Example 10

After laser exposure, a plate comprising Coating A was pre-heated at 105° C. for 40 seconds, then processed through a Protek XPH85 processor containing N200 developer at 78° F. The processing speed was set at 4 feet per minute. Any coating not addressed by the laser was easily removed by the developer. The plate was then subject to the 250 mJ/cm² post development UV exposure. This plate received a score of 6 for the polymerization test.

Comparing Example 1 with Example 3: A UV post-development exposure clearly increased the polymerization and therefore the durability of the coating.

Comparing Example 2 with Example 4: A UV post-development exposure clearly increased the polymerization and therefore the durability of the coating.

Comparing Example 5 with Example 6: A UV post-development exposure clearly increased the polymerization and therefore the durability of the coating.

Comparing Example 3 with Example 6: A pre-heat step is unnecessary for satisfactory practice of the disclosed method. Conventional violet plates utilize a pre-heat step, which is an energy intensive process.

Comparing Example 7 with Example 8: When the plate is processed in strong chemical developer, the image becomes much less susceptible to further reactions under post UV exposure.

Comparing Examples 1, 3, 9 and 10: When the plate is processed in a strong chemical developer, the image becomes much less susceptible to further reactions under post UV exposure.

It should be appreciated that as used herein, “reactions” refer to cross linking. The invention can be practiced even if the coating resin is partially dissolved during development, as long as enough unreacted material remains so that the post treatment increases the cross linking. The additional cross linking is achieved after all the unimaged coating areas have been removed from the substrate.

In the foregoing examples, the unimaged coating areas are removed at least in part by a chemical effect, such as dispersion, solubilization or dissolution. The reason for this is that the Verti wash has a mildly alkaline pH. The binder resin is a highly carboxylated styrene/acrylic resin that is soluble at the pH of the Verti wash. The violet imaging radiation initiates enough cross linking of the monomer to prevent dissolution of the imaged coating. The binder resin is not changed; it (and all the other components) is held in place by the matrix formed by the partially cross linked monomer. Since the binder resin is the only component that is alkali soluble (and it is being prevented from solubilizing due to the matrix formed by the partially cross linked monomer) all of the reactive ingredients remain to undergo further cross linking by the post exposure to radiation.

In a similar vein, the coating could have an adhesive promoter to help keep the coating on the substrate before imaging, and the wash could have a surfactant or similar agent for emulsifying the adhesive promoter and thereby helping mechanical action of the brushes remove the unimaged areas during development. This is in essence, a modified mechanical development. Imaging enables the cross linking of the material in the image areas to become entangled with the rough surface of the substrate and thereby prevent the surfactant from undermining the integrity and active ingredients in the imaged areas. Any loss in coating weight was found to be no more than about one percent, i.e., at least 98% of coating weight is retained.

As shown in Tables K and L below, the UV post treatment described above with respect to the inventive coating and method is significantly enhanced by combination with elevating the temperature of the surface of the plate.

TABLE K
Violet Imaging With Modified Mechanical Development
(Varied Post Exposure Treatments for % Conversion)
(All exposures at 40 micro joules)

| | |
|---|---|
| Exposure only | 66% |
| Exposure + Pre Heat | 69% (+5%) |
| Exposure + Post UV Cure | 70% (+6%) |
| Exposure + Post IR Cure | 72% (+9%) |
| Exposure + Post UV&IR Cure | 80% (+21%) |

The numbers in parentheses in Table K show the per cent increase in double bond conversion with pre-heat or post treatment, relative to the conversion due to imaging exposure only. As shown, the dual post treatment of violet imaged plates increases the conversion by at least 20%.

TABLE L
Performed under same conditions as Table K on
AGFA-N94 Violet Plate

| | |
|---|---|
| Exposure only | 60% |
| Exposure + Pre Heat | 64% |
| Exposure + Post UV Cure | N/A* |
| Exposure + Post IR Cure | N/A* |
| Exposure + Post UV&IR Cure | N/A* |

The asterisk (*) in Table L indicates that none of the post energy tests could be performed because the N-94 plate lost 90% of its image when developed without a pre-heat treatment.

The inventive method described herein provides a lithographic printing plate with high resolution and long press life via a dramatically simplified process, including no pre-heat step prior to development. An additional advancement is achieved since the described method is appropriate for use when the imaging step is performed with lower energy, including by exposure to violet radiation, which typically requires pre-heat prior to development to achieve a printing plate with long on-press life.

While a preferred embodiment has been set forth for purposes of illustration, the foregoing description should not be deemed a limitation of the invention herein. Accordingly, various modifications, adaptations and alternatives may occur to one skilled in the art without departing from the spirit of the invention and scope of the claimed coverage.

What is claimed is:

1. A method for pre-press production of a lithographic printing plate from a negative working, radiation imageable plate having an oleophilic resin coating material containing active ingredients that participate in cross-linking reactions to radiation and is non-ionically adhered to a hydrophilic substrate, comprising the steps of:
(a) imagewise radiation exposing the coating to produce an imaged plate having image areas with partially reacted resin material at an initial double bond conversion per cent and nonimage areas of resin material that are completely unreacted;
(b) without preheating, developing the plate with brushes in an aqueous solution to remove only the unreacted, nonimage areas from the substrate while retaining unreacted material in the image areas; and
(c) blanket exposing the developed plate to an external source of energy which further reacts the retained unreacted material in the image areas, thereby increasing the initial double bond conversion by at least about 5 per cent.

2. The method of claim 1, wherein the external source of energy in step (c) is at least one of IR and UV radiation.

3. The method of claim 2, wherein the blanket exposure includes both IR and UV radiation.

4. The method of claim 1, wherein the imagewise radiation exposure is with a source of violet radiation.

5. The method of claim 1, wherein the imagewise radiation exposure is with a source of violet radiation and the blanket exposure includes both IR and UV radiation.

6. The method of claim 1, wherein blanket exposure of the developed plate increases the initial double bond conversion by at least about 10 per cent.

7. The method of claim 1, wherein blanket exposure of the developed plate increases the initial double bond conversion by at least about 20 per cent.

8. The method of claim 1, including
imagewise exposing the coating to violet radiation within the range of about 40-65 μJ/cm²;
increasing the temperature of the plate after development to at least about 120° C.;
blanket exposing the plate to a source of UV energy while the plate is at said increased temperature, thereby increasing the initial double bond conversion by at least about 20 per cent.

9. The method of claim 1, comprising blanket exposing the developed plate with an external source of UV energy while the plate is heated above ambient temperature, which increases the initial double bond conversion by at least about 20 per cent.

10. The method of claim 9, wherein at least about 30% of the total double bond conversion after said blanket exposure, is achieved during said blanket exposure at elevated temperature.

11. The method of claim 1, wherein the plate is developed in an aqueous solution that includes anionic surfactants, nonionic surfactants and silica.

12. The method of claim 1, wherein the nonimage areas are removed at least partially by dissolution or solubilization in the aqueous solution.

13. The method of claim 1, wherein the plate is blanket radiation exposed via conveyance under an IR lamp to elevate the plate temperature and then conveyance under a UV lamp while the temperature is elevated.

14. The method of claim 1, wherein the plate has a nominal coating weight in the image areas before developing and the image areas substantially retain the nominal coating weight through completion of the blanket exposure.

15. The method of claim 1, wherein the coating is covered by a water soluble oxygen barrier top coat, and the imaged plate is developed by
delivering the imaged plate to a developing station containing a single developing tank where the aqueous solution is delivered at rotating brushes; and
conveying the imaged plate through the tank while contacting the plate with the aqueous solution and brushes, thereby (i) dissolving the top coat, (ii) developing the plate by substantially completely removing only the unreacted, nonimage areas from the substrate while retaining unreacted material in the image areas, thereby producing a developed surface, and (iii) conditioning the developed surface of the plate, all in said single tank.

16. The method of claim 15, wherein said conditioning includes enhancing the hydrophilicity of the substrate where the nonimage areas have been removed and forming a protective film on the plate.

17. The method of claim 15, wherein developing removes at least 98% of the coating material in the unreacted, nonimage areas from the substrate while none of the coating material in the image areas is removed.

18. The method of claim 15, wherein the aqueous solution includes water soluble resins, anionic surfactants, nonionic surfactants and silica.

19. A method for producing a lithographic printing plate from a negative working, radiation imageable plate having an oleophilic resin coating material that reacts to radiation by cross linking and is non-ionically adhered to a hydrophilic substrate, comprising:
imagewise radiation exposing the coating to a source of violet radiation to produce an imaged plate having partially reacted image areas at an initial double bond conversion per cent including unreacted coating material, and completely unreacted nonimage areas;
without pre-heat, developing the plate in an aqueous solution to remove only the unreacted, nonimage areas from the substrate while retaining unreacted material in the image areas; and
blanket exposing the developed plate with an external source of UV energy while the plate is heated above ambient temperature, thereby further reacting the retained unreacted material in the image areas and increasing the double bond conversion by at least about 10%.

20. The method of claim 19, wherein the plate has a nominal coating weight before developing and the image areas substantially retain the nominal coating weight through completion of the blanket exposure.

21. The method of claim 19, wherein the blanket exposing at above ambient temperature increases the double bond conversion by at least about 20%.

22. The method of claim 19, wherein at least about 15% of the total cross linking after said blanket exposure, was achieved during said blanket exposure at elevated temperature.

23. The method of claim 19, wherein developing removes at least 98% of the coating material in the unreacted, nonimage areas from the substrate while none of the coating material in the image areas is removed.

24. The method of claim 19, wherein the plate is developed in an aqueous wash including water soluble resins, anionic surfactants, nonionic surfactants and silica.

25. The method of claim 19, wherein the temperature of the plate during blanket exposure is above 120° C.

26. The method of claim 25, wherein the plate is imaged within the range of about 40-65 μJ/cm².

27. The method of claim 19, wherein the UV blanket exposure is about 250 mJ/cm².
